(19) United States
(12) Patent Application Publication
(10) Pub. No.: US 2002/0191812 A1
(43) Pub. Date: Dec. 19, 2002

(54) Object edge watermarking

(76) Inventor: Nam-Deuk Kim, Sherwood, OR (US)

Correspondence Address: DIGIMARC CORPORATION, 19801 SW 72ND AVENUE, SUITE 100, TUALATIN, OR, 97062, US

(21) Appl. No.: 10/131,584

(22) Filed: Apr. 23, 2002

Related U.S. Application Data
(60) Provisional application No. 60/286,239, filed on Apr. 24, 2001.

(51) Int. Cl. G06K 9/00

(52) U.S. Cl. 382/100

(57) ABSTRACT

The disclosure provides a method of imperceptibly embedding auxiliary information along object edges in image signals. It also provides a method of decoding this auxiliary information from image signals.

The object edge digital watermarking method may be used in combination with digital watermarking techniques that encode auxiliary data across image regions, such as image blocks. For example, a digital watermark embedder may be programmed to adapt its embedding technique based on the attributes of the image signal. For parts of an image that have strong edges surrounded by smooth regions, the object edge embedding technique is used, while in other parts that have high a degree of signal activity (e.g., busyness or texture), a region based encoding technique that takes advantage of the masking properties of high signal activity is used.

### TECHNICAL FIELD

The present application claims benefit of provisional application No. 60/286,239, filed Apr. 24, 2001, which is hereby incorporated by reference.

### BACKGROUND AND SUMMARY

Digital watermarking is a process for modifying physical or electronic media to embed a machine-readable code into the media. The media may be modified such that the embedded code is imperceptible or nearly imperceptible to the user, yet may be detected through an automated detection process. Most commonly, digital watermarking is applied to media signals such as images, audio signals, and video signals. However, it may also be applied to other types of media objects, including documents (e.g., through line, word or character shifting), software, multi-dimensional graphics models, and surface textures of objects.

Digital watermarking systems typically have two primary components: an encoder that embeds the watermark in a host media signal, and a decoder that detects and reads the embedded watermark from a signal suspected of containing a watermark (a suspect signal). The encoder embeds a watermark by altering the host media signal. The reading component analyzes a suspect signal to detect whether a watermark is present. In applications where the watermark encodes information, the reader extracts this information from the detected watermark.

Several particular watermarking techniques have been developed. The reader is presumed to be familiar with the literature in this field. Particular techniques for embedding and detecting imperceptible watermarks in media signals are detailed in the assignee's co-pending application Ser. No. 09/503,881 and U.S. Pat. No. 6,122,403, which are hereby incorporated by reference.

The invention provides a method of imperceptibly embedding auxiliary information along object edges in image signals. It also provides a method of decoding this auxiliary information from image signals.

The object edge digital watermarking method may be used in combination with digital watermarking techniques that encode auxiliary data across image regions, such as image blocks. For example, a digital watermark embedder may be programmed to adapt its embedding technique based on the attributes of the image signal. For parts of an image that have strong edges surrounded by smooth regions, the object edge embedding technique is used, while in other parts that have high a degree of signal activity (e.g., busyness or texture), a region based encoding technique that takes advantage of the masking properties of high signal activity is used.

### DETAILED DESCRIPTION

The following detailed description describes digital watermarking system for image signals that employs object edge watermarking along with an alternative region based digital watermarking method. These techniques may be applied to both still and moving image signals (e.g., video).

Object Edge Digital Watermark Embedding

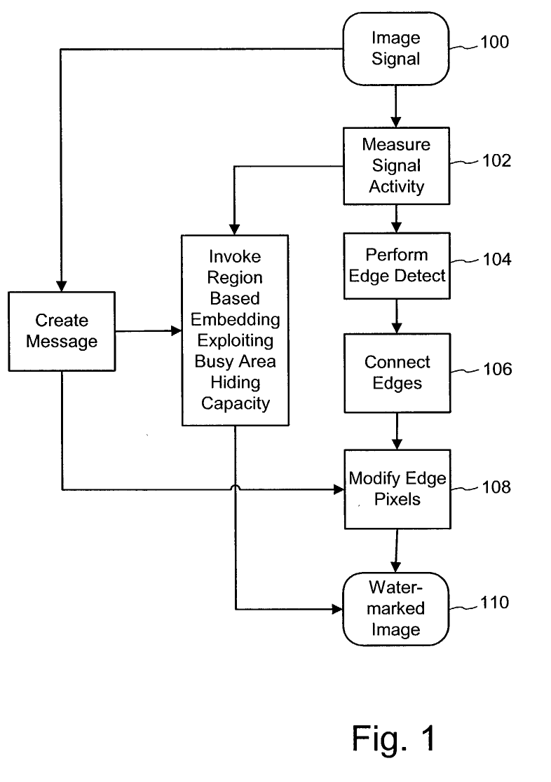

FIG. 1 is a flow diagram illustrating a digital watermark embedding process that uses object edge embedding. The process receives an input image 100 and segments the image into tiles of pixels (e.g., ranging from 64 to 512 pixels in width and height). It then checks the signal activity over the tile (102). Signal activity may be measured in a variety of ways. One way is to measure the high frequency content of the image signal within a block. Another way is to measure statistical measures of activity, such as variance or a sum of the square of mean removed values within a tile. Combinations of the spectral and statistical measures are preferably used to find a composite measurement of signal activity. Blocks that produce a high measure of signal activity due to connected edges are treated as better candidates for object edge embedding than region based embedding.

If the signal activity measurement indicates that the tile has a high level of busyness or texture, then the embedder invokes a region based embedding method to exploit the data hiding capacity of the busy image areas. Examples of suitable embedding methods are described in pending U.S. patent application Ser. No. 09/503,881 and U.S. Pat. No. 6,122,403. For still images and video, the region based embedder modifies two-dimensional regions of pixels, increasing the signal gain of the watermark signal in busy regions of the image signal. One specific example of a 2D region based embedding technique that exploits busyness is to modulate a message with a 2D pseudorandom carrier signal to form a pseudorandom watermark signal, scale the signal based on a measure of data hiding capacity in a 2D region being modified, and then add the resulting signal to the image. A variety of spatial and frequency domain embedding methods for region based embedding are described in digital watermarking literature. The carrier signal need not be pseudorandom. Also, the watermark signal may be embedded by adjusting attributes of pixels in a 2D region so that they correspond to attributes associated with message symbols to be encoded. Some examples of image attributes include spatial domain values, transform coefficients (e.g., wavelet, DCT, Fourier, Hadamard, autocorrelation coefficients, etc.), or other features of the host signal.

If the tile has low signal activity, yet has well-defined object edges, it is a candidate for object edge embedding. This embedding technique identifies connected pixels that lie along a strong edge in the tile, and embeds a message by modifying the pixel values along that edge.

The edge embedder first performs edge detection (104). Examples of edge detection methods include Canny edge detection or Sobel edge detection. Next, the edge embedder connects the edges. A further discussion of edge detection and connection follows in the next section.

The embedder creates a message for embedding into the image. In the example implementation, the same message is embedded in tiles that use object edge embedding and region based embedding. However, alternative implementations may embed different messages in different tiles. Also, while each tile may carry the same message, the message signal may differ due to differences in the message carrier signal and differences in the host image signal. To create the message, the embedder takes an N-bit binary message, which becomes the message payload, and appends an index sequence comprising a fixed sequence of binary or M-ary symbols. It also includes error detection symbols for both the index and message payload portions. Finally, it performs error correction coding, employing either convolution coding or turbo coding. Error correction coding may also include repeating the index portion and/or the message payload portion two or more times before applying the convolution or turbo coder to create an error correction encoded sequence.

Next, the message creator spreads each bit of the error correction encoded sequence over a pseudo-random sequence (PN sequence). There are several alternative ways to perform message spreading, such as multiplying the error correction encoded message with the PN sequence (both signals in binary antipodal sequence of values {−1, 1}, computing an exclusive OR between the error correction encoded message sequence and PN sequence, convolving the message sequence with a random carrier signal, etc. The resulting spread message signal is formed into a one-dimensional symmetric signal that can be read from either direction along edge pixels. However, the message signal need not be symmetric. Alternative message synchronization techniques can be used to facilitate reading the message in either direction along an edge without making the message symmetric. For example, special sequence can be inserted adjacent the index portion to specify the direction of the message along an edge.

Next, the object edge embedder modifies pixels along the edges formed in stages 104 and 106 according to the message signal. In one approach, the embedder adjusts luminance of pixels up or down along an edge according to a binary antipodal message signal values of {1, −1}, respectively. The amount of adjustment is scaled according to a gain vector.

The object edge embedder calculates a gain vector with elements in the vector corresponding to edge elements and each gain element value based on edge strength derived from slope of edge and distance between high and low pixel values on either side of edge. The gain element may be linearly or non-linearly related to the strength of the edge. The embedder multiplies the message signal by corresponding gain vector elements and adds the resulting signal to corresponding edge elements in the host image.

This process represents only one example of an embedding function. Another embedding function associates pixel levels with possible message symbols in a symbol alphabet. Then, to encode a string of message symbols, the embedder reads the edge pixel value, finds the corresponding pixel level associated with the symbol to be encoded that is closest to the edge pixel value, and replaces the edge pixel value with the pixel level from the symbol alphabet. This is a form of quantization embedding where the pixel values of edge pixels are quantized to levels corresponding to symbols (e.g., binary or M-ary symbols) to be encoded into the edge pixels.

The result of the process of FIG. 1 is a watermarked image signal, potentially including some tiles marked using the object edge embedding technique and some using the region based approach.

As an alternative to the above approach, the embedder may detect and connect edges and then embed auxiliary data by modifying pixel values at predetermined angle and distance from the edge. For example, the embedder first detects and connects the edges and then uses the region based embedding technique, e.g., adding a scaled PN watermark signal block to a corresponding block of pixels at a predetermined distance and angle from the edge. As another example, the embedder may add a one dimensional watermark signal along a line of pixels at a particular angle with the edge, such as a line orthogonal to the edge. This process may be repeated at several block or line locations and orientations relative to the edge.

While this approach does not have the advantage of exploiting the data hiding attributes of the edge pixels themselves, it does enable the decoder to synchronize with the watermark signal using the object edge as a reference. In particular, the decoder first detects and connects the edge. It then uses the location of the edge as reference to determine the block location and orientation of a block based watermark signal, or alternatively, the location and orientation of a linear watermark signal. The decoder then extracts the watermark from the block or line of pixels found relative to the edge using the techniques described or referenced in this document. The watermark signal may be embedded at a variety of locations and block shapes relative to the connected edge.

Edge Detection and Connection

This section details an example implementation of object edge detection and connection. Edge detection algorithms have been well studied and evaluated in image processing literature. See J. S. Lim, Two-Dimensional Signal and Image Processing, pp. 476-495, PTR Prentice Hall, New Jersey, 1990; and W. K. Pratt, Digital Image Processing, pp. 478-492, John Wiley & Sons, New York, 1978. Typical edge detection processes define an edge as a “step discontinuity in the image signal”, and attempt to locate edges by convolving the image with a kernel that approximates a first or second derivative. See, for example, P. Kovesi, “Lecture 6, Classical Feature Detection,” http://www.cs.uwa.edu.au/undergraduate/courses/233.412/Lectures/Lecture6/lecture6.ht ml, The University of Western Australia, 2000.

Using a first derivative kernel, an edge occurs at local maxima, while for second derivatives, edges occur at the zero crossings. John F. Canny developed a standard in edge detection. See, J. F. Canny, “A computational approach to edge detection,” IEEE Trans. Pattern Analysis and Machine Intelligence, 8, pp. 679-698, 1986. This edge detection method starts by convolving an image with a 2-D Gaussian filter, and then differentiating this smoothed image in two orthogonal directions. By calculating the derivative in two orthogonal directions, one can determine the overall gradient direction and amplitude. Using this knowledge, the implementation then suppresses points which were non-maxima and values that were not local peaks. The final step involves thresholding the edges. Two threshold values are used. The first threshold, which is larger than the second, identifies most of the true edges. However, some discontinuities in edges may occur using this higher value, so pixels which are connected to these high threshold edges are also considered edges if they are above the second, smaller threshold. The resulting map typically provides a very good representation of the edges in the image.

The edge map provided by the Canny edge detection algorithm does not attempt to differentiate between connected edges and areas with a high concentration of random edge like textures. For example, for images with random edge like textures like images of hair or fur, a Canny edge algorithm might construct the edge map in which the image portions depicting hair or fur are said to contain a high concentration of edges. However, the purpose of the edge map is to highlight connected edges to avoid for region based embedding, and to use as candidates for object edge embedding. The fur area should be able to hold a good deal of watermark signal using a region based approach, since the so-called edges are really a somewhat random texture, and placing a pseudorandom signal in this texture is unlikely to be noticed. Thus, we modify Canny's edge detection algorithm to ignore random, closely packed edges in the following fashion. First, we take the edge map provided by Canny's algorithm and smear it with a 5×5 or 7×7 low pass filter kernel. This causes closely packed edges to bleed into one another. Next, we thin this smeared edge map using a min filter of a slightly higher order than the smear. This causes edges which were stretched to contract back in tighter than the original Canny edge mask. A composite, binary edge mask is then constructed by saying a pixel is on an edge if and only if the original Canny edge mask says it is an edge, but the min-filtered, smeared Canny Edge mask says it is not. This operation essentially allows edges that are boundary edges to remain, while closely packed edges disappear. The final step grows the edge map by a suitable radius to protect all pixels which may inadvertently be called “high contrast” areas due to these edges.

The edge map specifies the pixel locations along edges that are candidates for encoding the watermark signal as described above., and for decoding the watermark signal as described below.

Watermark Decoding

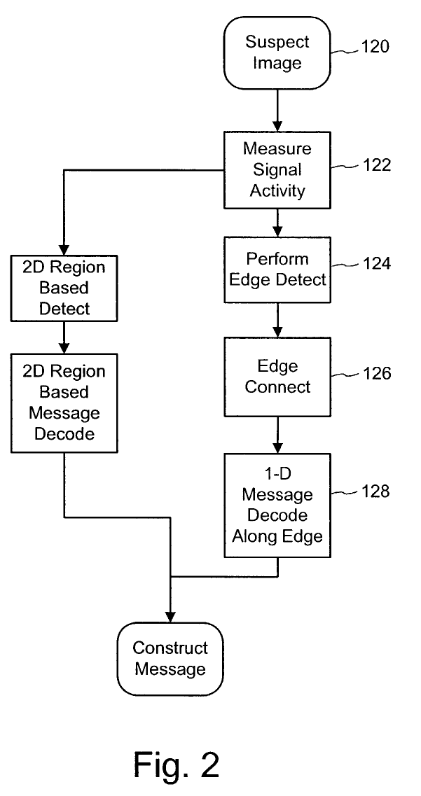

FIG. 2 is a flow diagram illustrating a process for decoding auxiliary message data from an image. This process operates on image data suspected of containing a watermark signal. The image data may be captured from a web cam or scanner of a watermarked object (e.g., an object or document on which a watermarked image has been printed). It also operates on digital images and video content.

The watermark decoder operates on tiles of the suspect image 120. It first determines whether to apply object edge decoding on a tile of pixels by measuring signal activity in the tile using a technique similar to the one used in the embedder. If the tile has high signal activity, not attributed to connected edges, then it is processed using a 2D region based detection method compatible with the region based embedder. Examples of suitable region based digital watermark decoding methods are described in pending U.S. patent application Ser. No. 09/503,881 and U.S. Pat. No. 6,122,403. These methods perform a detection operation to detect the presence and orientation of the 2D watermarked signal region, and then perform message decoding on the 2D watermarked signal region.

If the signal activity analysis indicates that a tile has strong connected edges, the decoder processes the tile using an object edge decoding process illustrated in stages 122-128 of FIG. 2. In this process, the object edge decoder repeats the automated edge detection and edge connection process as in the embedder. It then evaluates the pixels along the edge, searching for index portions of the embedded message. The distance between two index locations is used to determine the scale of the image. Compensating for image scale, the decoder extracts estimates of the bits in the message signal, and then performs error correction decoding to reconstruct the message payload. The error detection bits are used to identify valid index sequences and payload messages.

This technique is robust to geometric distortion of the watermarked image because it decodes along the direction of the edge and uses the index to compensate for scale distortion. If the image is rotated or shifted, the decoder is capable of detecting the edge and decoding along that edge.

In one implementation compatible with the embedder, the decoder performs 1-D correlation of detected edge elements with the known index sequence. In the case where the index is modulated with a known carrier signal and added to the edge pixel values, the decoder first performs a correlation between the edge pixel values and the known carrier signal of the index sequence. To improve performance, the edge pixel values can be filtered to de-correlate the embedded carrier signal from the host pixel values. One form of decorrelation filter is to compare with each adjacent pixel value and replace the center pixel value with positive value if the center is greater than its neighbors, or a negative value if it is less than its neighbors. The location of maximum correlation provides the location of the index.

In the case where the index is embedded by quantizing edge pixel values, the decoder determines the quantization level and then finds the symbol corresponding to that level. The symbols produced by this scheme are then correlated with the carrier signal for the index to locate a reference point and direction for further decoding of the embedded data along the edge.

The distance between index sequences along the edge provides the scale. The decoder then calibrates for scale, and performs message decoding by correlating 1-D edge signal with the carrier signal to get estimates of error correction encoded bits. Next, it performs error correction decoding of estimate values to construct a message payload. Finally, it performs error detection to check whether message is valid.

Message estimates from different tiles may be aggregated to improve robustness.

Additional Embodiments

The above object edge watermarking techniques can be implemented for a variety of applications. One application is photo identity cards or documents. In such applications, the object edge watermarking is performed along the silhouette of a person in the photo (e.g., the face or head and shoulders). In this case, the person represents the object, and the boundary of the person represents the object edge. The boundary may be calculated using image segmentation. In one implementation, the edge detector scans each row of pixels in a digital image representing the photo on the document, and detects the edge of the silhouette by determining pixel locations in the row where there is high variance in adjacent pixel values. Another form of segmentation for photo ID's is skin tone segmentation. This type of segmentation identifies the boundary of human objects (e.g., a face) based on color information associated with skin tones.

After identifying the edge, the digital watermark embedder applies the method described above to hide data along the object boundary. In addition, the interior region of the object may be embedded using the region based watermarking techniques described above. The data hidden in the edges or in the region within the edges may be used to carry data about the person depicted in the photo, or data from the card, such as a hash of the person's name, date of birth, identification number, etc.

To detect the watermark in the photo, the digital watermark reader operates on a digital image scanned from the photo ID. It begins by segmenting the image to identify the boundary of the person. It then extracts the object edge watermark from the pixels along the boundary, and extracts the region-based watermark from the pixels within the object edges (e.g., the head and shoulder region).

The object edge and region based watermarking schemes provide extra layers of security against counterfeiting for the photo ID document. One layer of security is provided by the image dependent attribute of the object edge watermark, which makes it difficult to copy from one image to another. Another layer of security is provided by embedding information about the person and data from the card in the object edge or region based digital watermarks. Another layer of security is provided by making the two digital watermarks related in some fashion, such as by embedding common or mathematically related payload data in each watermark, or embedding a key necessary to decode the other watermark in one of the watermarks. For example, one watermark stores a seed to a PN sequence generator, and the resulting PN sequence created from this seed serves as the carrier signal for the other watermark.

Concluding Remarks

Having described and illustrated the principles of the technology with reference to specific implementations, it will be recognized that the technology can be implemented in many other, different, forms. To provide a comprehensive disclosure without unduly lengthening the specification, applicants incorporate by reference the patents and patent applications referenced above.

The methods, processes, and systems described above may be implemented in hardware, software or a combination of hardware and software. For example, the auxiliary data encoding processes may be implemented in a programmable computer or a special purpose digital circuit. Similarly, auxiliary data decoding may be implemented in software, firmware, hardware, or combinations of software, firmware and hardware. The methods and processes described above may be implemented in programs executed from a system's memory (a computer readable medium, such as an electronic, optical or magnetic storage device).

The particular combinations of elements and features in the above-detailed embodiments are exemplary only; the interchanging and substitution of these teachings with other teachings in this and the incorporated-by-reference patents/applications are also contemplated.

I claim:

1. A method of imperceptibly embedding auxiliary data into an image signal comprising:
detecting an object edge in the image signal;
forming a connected edge;
creating a message signal to be embedded into the connected edge;
modifying pixel values along the connected edge to encode the message signal such that the message signal is substantially imperceptible in the image signal when viewed.

2. The method of claim 1 further including:
performing an analysis of signal activity in the image signal; and based on the analysis of the signal activity, selecting a 2D region based digital watermarking method or the object edge digital watermarking method of claim 1 to embed the auxiliary data in the image signal.

3. The method of claim 1 wherein modifying includes adding a carrier signal modulated with an N-bit message to the pixel values along the connected edge.

4. The method of claim 1 wherein modifying includes quantizing features of the connected edge so that the quantized features correspond to symbols in the message signal.

5. A computer readable medium on which is stored software for performing the method of claim 1.

6. A computer readable medium on which is stored software for performing a method comprising:
detecting an object edge in the image signal;
evaluating pixel values along the edge to detect presence of a hidden index;
using the index to detect a variable message hidden at a predetermined spatial location relative to the edge; and
decoding the variable message from pixel values at the predetermined spatial location relative to the edge.

7. A physical object carrying an image signal that has been encoded with auxiliary data according to the method of claim 1.

8. A method of decoding auxiliary data that has been imperceptibly embedded into an image signal comprising:
detecting an object edge in the image signal;
forming a connected edge;
evaluating pixel values along the connected edge to detect presence of the auxiliary data; and
decoding the auxiliary data from the pixel values along the connected edge.

9. The method of claim 8 including:
detecting an index signal embedded along the connected edge; and using the index to determine direction of embedding along the connected edge.

10. The method of claim 9 including:
two or more detected index signals to determine scale; and using the determined scale to decode the auxiliary data from the pixel values along the connected edge.

11. The method of claim 8 wherein decoding includes performing a 1-dimensional correlation between a carrier signal and pixel values along the connected edge.

12. The method of claim 8 wherein decoding includes quantizing pixel features along the connected edge to determine embedded message symbols associated with the quantized features.

13. A computer readable medium on which is stored software for performing the method of claim 8.
